(19) United States
(12) Patent Application Publication
(10) Pub. No.: US 2006/0193366 A1
(43) Pub. Date: Aug. 31, 2006

(54) Heating element structure with efficient heat generation and mechanical stability

(75) Inventors: Arsalan Emami, Aliso Viejo, CA (US); Mitch Agamohamadi, Orange, CA (US); Saeed Sedehi, Orange, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: NexTherm, Inc.

(21) Appl. No.: 11/338,132

(22) Filed: Jan. 23, 2006

Related U.S. Application Data
(60) Provisional application No. 60/646,383, filed on Jan. 24, 2005.

(51) Int. Cl. H05B 3/62

(52) U.S. Cl. 373/119; 373/117

(57) ABSTRACT

An embodiment of the present invention is a heating element structure. A first tray has an inner boundary and an outer boundary. The inner and outer boundaries define a space. A first heating element fit to the first tray and surrounding the inner boundary generates heat when power is applied. The heating element expands in the space within a temperature range.

### RELATED APPLICATION

This patent application claims the benefits of U.S. Provisional Application, titled “Heating Element With Efficient Heat Generation And Mechanical Stability”, Ser. No. 60/646,383, filing date Jan. 24, 2005.

### BACKGROUND

1. Field of the Invention

Embodiments of the invention relate to the field of furnaces, and more specifically, to heating element structure in furnaces.

2. Description of Related Art

Furnaces typically use resistance wires as heating elements. Many applications using furnaces require the heaters to be responsive to temperature changes and maintain a uniform temperature over some time period. A resistance wire typically goes through many thermal cycles during its life. Resistance wires expand, grow, or elongate due to exposure to high temperatures over time. When these wires are held firmly by ceramic separators at some fixed points for mechanical stability, they may expand or elongate beyond these points, leading to premature failure or break.

Existing techniques to provide reliable wire heating elements have a number of drawbacks. One technique uses ceramic separators to restrain the wire heating elements and provide space in the separators for wire elongation. This technique requires using several separators that are embedded in the insulator layer, leading to assembly difficulty and increased cost. In addition, it limits the elongation within the separators. Another technique uses a number of anchors to secure the wires. The anchors are fit to anchor recesses having radial and retaining grooves. This technique requires using specially designed anchors and anchor recesses. It also confines the elongation to within the grooves.

### BRIEF DESCRIPTION OF THE DRAWINGS

Embodiments of invention may best be understood by referring to the following description and accompanying drawings that are used to illustrate embodiments of the invention. In the drawings:

FIG. 1 is a diagram illustrating a system in which one embodiment of the invention may be practiced.

FIG. 2 is a diagram illustrating a heating core according to one embodiment of the invention.

FIG. 3 is a diagram illustrating top view of a heating element structure according to one embodiment of the invention.

FIG. 4A is a diagram illustrating a tray according to one embodiment of the invention.

FIG. 4B is a diagram illustrating a tray with attached posts according to one embodiment of the invention.

FIG. 4C is a diagram illustrating a tray with integrated posts according to one embodiment of the invention.

FIG. 4D is a diagram illustrating a tray with vertical bars according to one embodiment of the invention.

FIG. 5 is a diagram illustrating a connecting bar and a power bar according to one embodiment of the invention.

FIG. 6 is a flowchart illustrating a process to form the heating core according to one embodiment of the invention.

FIG. 7 is a flowchart illustrating a process to form a tray according to one embodiment of the invention.

FIG. 8 is a diagram illustrating a system using machined or formed channel according to one embodiment of the invention.

FIG. 9 is a diagram illustrating a heating core according to one embodiment of the invention.

FIG. 10 is a diagram illustrating a formed channel according to one embodiment of the invention.

### DESCRIPTION

An embodiment of the present invention is a heating element structure. A first tray has an inner boundary and an outer boundary. The inner and outer boundaries define a space. A first heating element fit to the first tray and surrounding the inner boundary generates heat when power is applied. The heating element expands in the space within a temperature range.

In the following description, numerous specific details are set forth. However, it is understood that embodiments of the invention may be practiced without these specific details. In other instances, well-known circuits, structures, and techniques have not been shown to avoid obscuring the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

An embodiment of the invention is a heating element structure used in a furnace. The furnace may be positioned horizontally or vertically. The furnace includes a heating core. The heating core has a number of heating element structures stacked on each other. Each of the heating element structures includes a tray and a heating element placed around the tray. The tray may have a number of embodiments. In one embodiment, the tray includes a ring and a disk. The ring has a number of slots or holes to provide an efficient heat transfer when the heating element generates heat. The disk is attached to the ring and provides at least one of a horizontal space and a vertical space to allow expansion or elongation of the heating element when the heating element is exposed to high temperatures over time. The heating element structure provides an efficient heat generation and mechanical stability. By providing the space to allow growth of the heating element, the life of the heating element may be prolonged, avoiding premature failure. In addition, the heating element structures are simple to construct, allowing easy construction of the heating core and reducing assembly costs. The tray assembly also provides highly reliable mechanical support to the heating elements in the heating core.

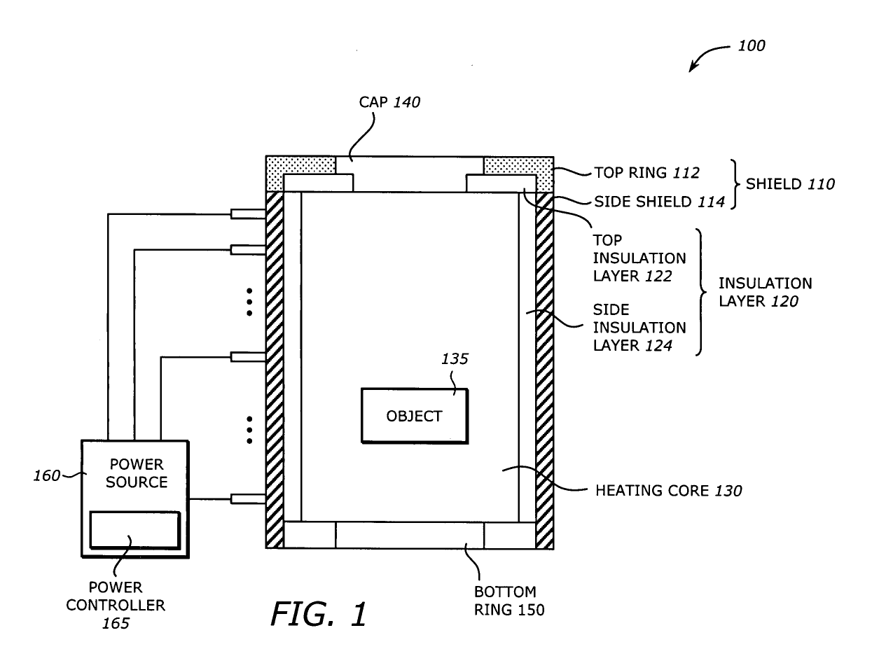

FIG. 1 is a diagram illustrating a system 100 in which one embodiment of the invention may be practiced. The system 100 represents a diffusion surface used to generate heat in thermal design or control applications. The system 100 includes a shield 110, an insulation layer 120, a heating core 130, a cap 140, a bottom ring 150, and a power source 160. Note that the system 100 may have more or less than the above components.

The shield, or shell, 110 provides a housing or enclosure to house or enclose the heating core 130. It may be made of stainless steel. It may include a top ring 112 to shield the top of the heating core 130 and a side shield 114. Typically the shield 110 has a shape of a circular, oval, or elliptic cylinder. The shield 110 may have structures, parts, or elements to provide mechanical and electrical support for power bars and thermocouples.

The insulation layer 120 provides insulation for the heating core 130. The insulation layer 120 includes a top insulation layer 122 and a side insulation layer 124. The insulation layer 120 may be made of any material that is highly resistant to heat, has a low temperature expansion coefficient, has a low heat transfer coefficient, and maintains its properties over time. An example of such material is a mixture of aluminum oxide (Al₂O₃) and silicon dioxide or silica (SiO₂). As is known by one skilled in the art, any other insulating materials having the above desirable characteristics may be used.

The heating core 130 provides heat generation to an object 135 placed inside the core. The object 135 may be any object, structure, element, or component that needs to be heated at some pre-defined temperature range. In one embodiment, the object 135 is a semiconductor wafer. The temperature range may be any suitable range as required, from 25° C. to 1700° C. For example, for semiconductor wafer applications, the temperature range may be between 500° C. to 1200° C. The heating core 130 has power bars to connect to the power source 160. The heating core 130 may provide heat to a number of zones inside the heating core 130. The heating zones may have different temperature ranges according to the requirements and specifications of the furnace. The power bars are allocated to correspond to the heating zones.

The cap 140 seals the heating core 130 at the top and provides an tight mechanical fit to the top ring 112 to reduce or minimize heat loss. The bottom ring 150 provides mechanical support for the heating core 130.

The power source 160 provides power to the heating core to generate heat when power is applied. The power source 160 is connected to the heating core 130 via the power bars. The power source 160 may have a power controller 165 that controls the amount of current and/or voltage to the heating core 130. By receiving different amounts of current or voltage via the individual power bars, the heating core 130 is able to generate different heat profiles in the corresponding heating zones.

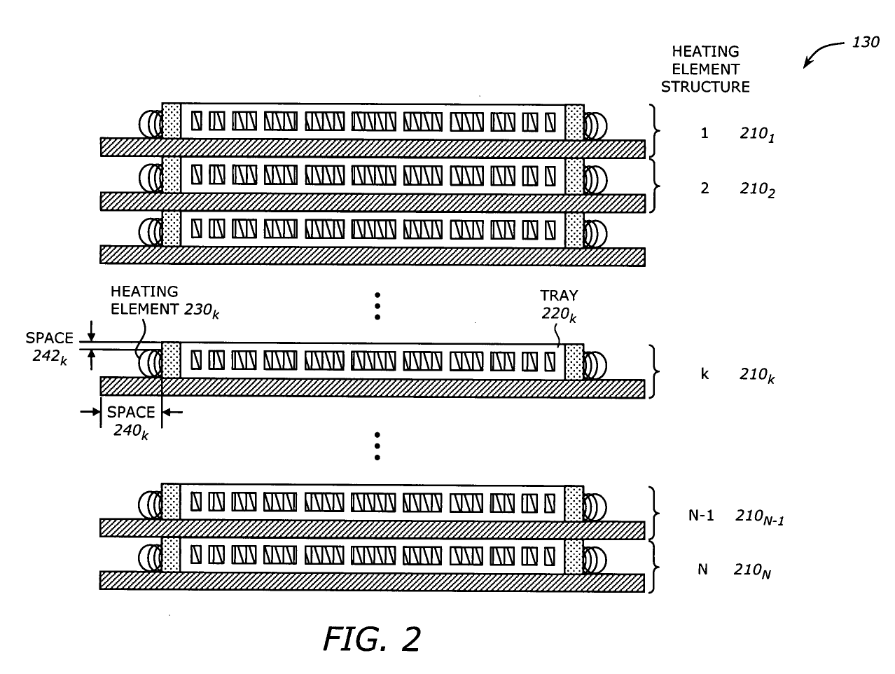

FIG. 2 is a diagram illustrating the heating core 130 according to one embodiment of the invention. FIG. 2 shows a cross-sectional view of the heating core 130 without connecting bars or power bars. The heating core 130 includes a plurality of heating element structures 210₁ to 210_{N}.

The heating element structures 210₁ to 210_{N} are aligned and stacked on one another. In one embodiment, the furnace 100 is a vertical furnace. The heating element structures 210₁ to 210_{N}, therefore, are stacked in a vertical direction. For a vertical arrangement, consideration is taken to ensure that the heating element structures at the bottom of the heating core 130 (e.g., the heating element structures 210_{N} and 210_{N-1}) are designed to sustain the weight of all the heating element structures above them. The number N of the heating element structures vary according to the applications or the number of zones divided in the heating area.

In general, the heating element structures 210₁ to 210_{N} have similar shape and construction style. Therefore, the construction and assembly of the heating core 130 are greatly simplified. The heating element structures 210ₖ (k=1, . . . , N) includes a tray 220ₖ and a heating element 230ₖ that fits to the tray 220ₖ. The heating element 230ₖ generates heat when power is applied. Due to constant heating, the heating element 230ₖ may expand or elongate over time. The construction of the tray 220ₖ allows a space 242ₖ in the vertical dimension and a space 250ₖ in the horizontal dimension to accommodate the expansion or elongation of the heating element 230ₖ. This prevents the deformation of or structural and/or mechanical damage to the heating element 230ₖ that may reduce the life of the heating element 230ₖ.

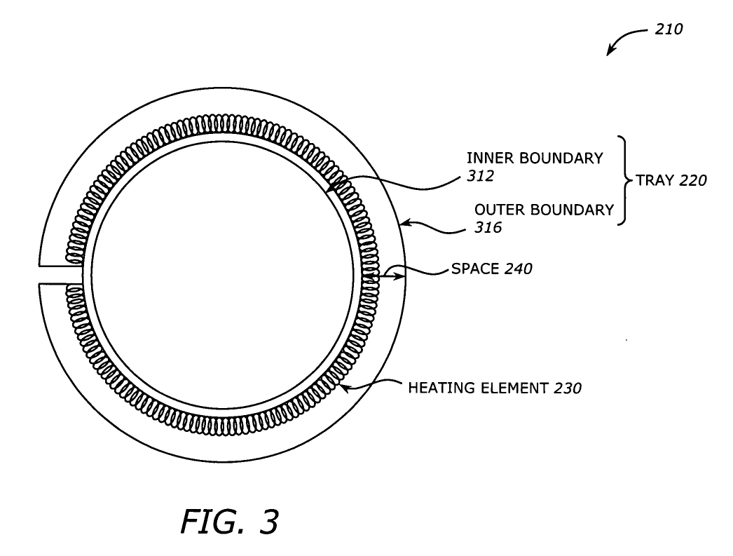

FIG. 3 is a diagram illustrating top view of the heating element structure 210 shown in FIG. 2 according to one embodiment of the invention. The heating element structure 210 includes a tray 220 and a heating element 230. The subscript k is dropped for clarity.

The tray 220 typically has a circular, oval, or elliptical shape that fits the inside of the housing provided by the shield 110 and the insulation layer 120 shown in FIG. 1. It has an inner boundary, or circumference, 312 and an outer boundary, or circumference, 316. The inner and outer boundaries defining a space 240. The space 240 may have a size or distance from 0.1 inch to 25 inches depending on the application, the temperature range, the heating element material, the coefficient of thermal expansion of the heating element, and other mechanical and/or electrical parameters.

The heating element 230 is fit to the tray 220 and surrounds the inner boundary 312 to generate heat when power is applied. The heating element 230 may expand or elongate in at least one of the spaces 240 and 242 within a temperature range. In essence, the spaces 240 and 242 allow expansion in both horizontal and vertical directions, or in three-dimensional space. The heating element 230 may be a wire having a wire shape. The wire shape may be one of a helical shape, a solid shape, and a flat shape. The helical shape provides a large surface area for high wattage without high watt density. For heating applications, the wire 230 may expand or elongate over time. It may not return to its original length after being exposed to high temperatures causing a continuous growth with temperature cycling. The spaces 240 and 242 provide sufficient room for the wire 230 to grow or expand over time. This prevents premature failure of the wire 230. The heating element 230 may be made of any suitable material for heat generation. Commonly used material may be Kanthal, Nikrothal, Super-Kanthal, Molybdenum Discilicide, etc. It may have a coefficient of thermal expansion of approximately 15E-6[K⁻¹] at 1000° C.

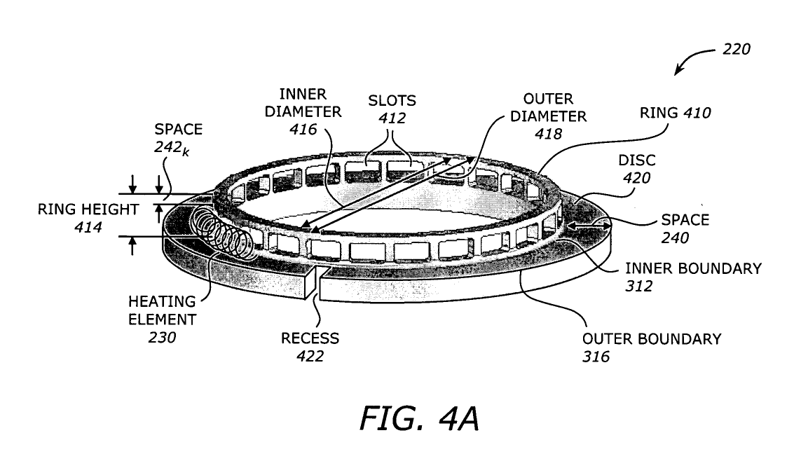

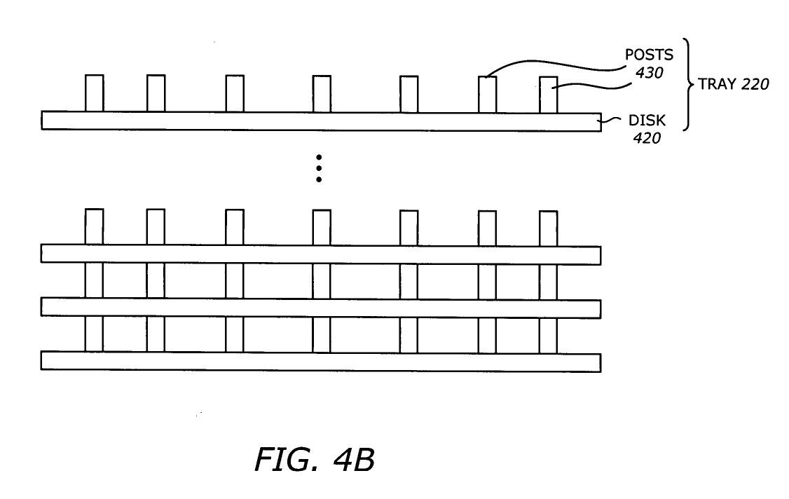

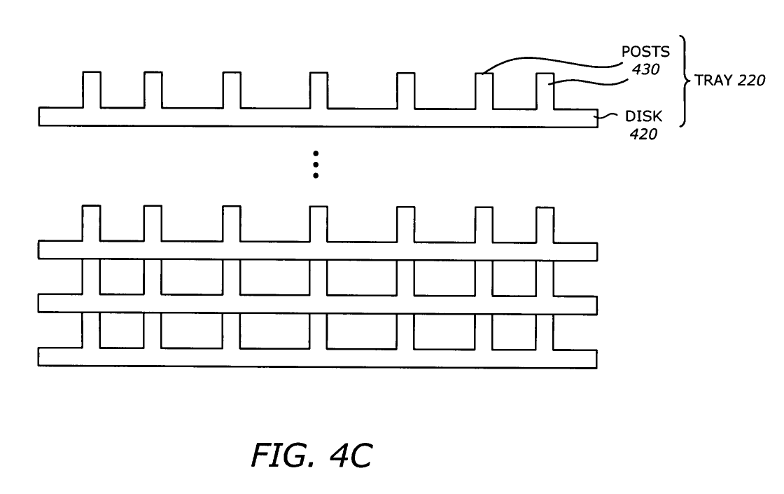

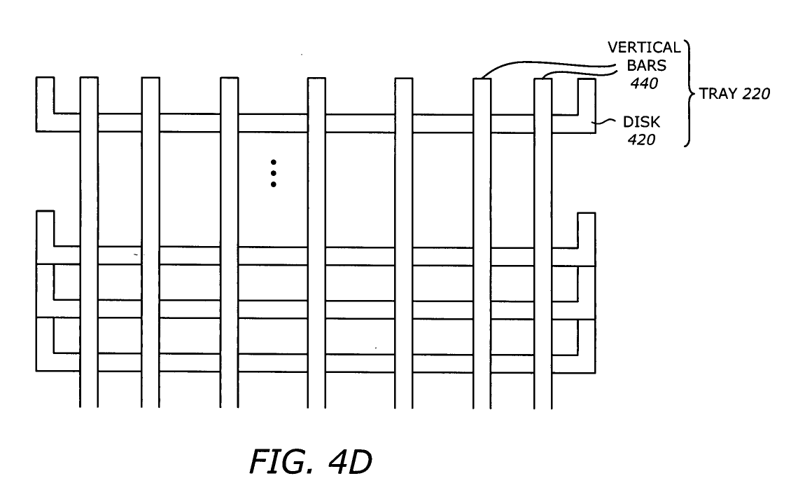

FIG. 4A is a diagram illustrating the tray 220 shown in FIG. 3 according to one embodiment of the invention. The tray 220 includes a ring 410 and a disk 420.

The ring 410 defines the inner boundary 312 and has a ring height 414. It has a plurality of slots, or holes, 412 spaced around the inner boundary 312. Typically, the slots 412 are spaced at equal distances to provide uniform heat transfer. The heating element 230 is placed around, or surrounds, the plurality of slots 412. For clarity, the heating element 230 is only shown partially in FIG. 4. The ring height 414 is selected to fit the diameter or the size of the heating element 230 such that there is the space 242 above the wire to allow for expansion. The size of the space 242 may be from 0 to about 50% of the size of the heating element 230. The plurality of slots 412 provide heat transfer when the heating element 230 generates heat. The generated heat may be transferred efficiently from the heating element 230 through the slots 412 to the center of the heating core 130. The ring 410 may have a shape that fits to the inside of the housing or the enclosure. Typically, the shape is a circle or oval. The ring 410 has an inner diameter 416 and an outer diameter 418 due to its thickness. The inner diameter 416 may range from 0.5 inch to several hundred inches. For semiconductor wafer applications, the inner diameter 416 of the ring 410 may be from 8 inches to 30 inches. The thickness of the ring 410 that defines the inner boundary may be approximately 0.5 inch, ranging from 0.1 inch to several inches. The ring height 414 may be from 0.25 inch to 50 inches depending on the size of the heating element 230 and other mechanical parameters. Typically, the ring height 414 may range from 1.5 inches to 1.8 inches. The ring 410 may be made of aluminum oxide (Al₂O₃) or silicon dioxide or silica (SiO₂), their equivalents, or any combination.

The disk 420 is attached to the ring 410 near or at the inner boundary 312. It may be attached to close to the inner or outer diameters 416 or 418 of the ring 410. It has or defines the outer boundary 316. The surface of the disk 420 essentially defines the space 330 between the inner boundary 312 and the outer boundary 316. The disk has a recess 422 so that a post or a bar may be inserted to align the stacked trays. In addition, the recess 422 may define the end of the heating element 230 where a connecting bar or a power bar may be connected. The disk 420 may have two recesses 422 on two sides of its diameter to provide two alignment points when the trays are stacked on one another. The disk may also be made of aluminum oxide or silica.

The ring 410 and the disk 420 may be attached together through any attachment mechanism such as welding or gluing. Alternatively, both may be integral to form a single-piece as the tray 220.

There may be several embodiments to form the ring 410. The purpose is to create a number of guides or posts around the inner boundary 312 and a number of slots or holes to provide efficient heat transfer from the heating element 230 to the core when power is applied.

FIG. 4B is a diagram illustrating a cross sectional view of the tray 220 with attached posts according to one embodiment of the invention. In this embodiment, the ring 410 shown in FIG. 4A is replaced by a number of vertical posts 430 attached to the disk 420 and spaced around the inner boundary 312. Any suitable mechanism may be used to attach the posts 430 to the disk 420 including welding, gluing, etc. When the trays are stacked on each other, the vertical posts 430 form slots similar to the slots 412 of the ring 410.

FIG. 4C is a diagram illustrating a cross sectional view of the tray 220 with integrated posts according to one embodiment of the invention. In this embodiment, the ring 410 shown in FIG. 4A is replaced by a number of vertical posts 430 that are integral or integrated to the disk 420 and spaced around the inner boundary 312. When the trays are stacked on each other, the vertical posts 430 form slots similar to the slots 412 of the ring 410. In this embodiment, the tray 220 may be considered to include only the disk 420 having the vertical posts 430.

FIG. 4D is a diagram illustrating a cross sectional view of the tray 220 with vertical bars according to one embodiment of the invention. In this embodiment, the ring 410 shown in FIG. 4A is replaced by a number of vertical bars 440 that are spaced around the inner boundary 312 and attached to the stacked disks at the inner boundary 312. The vertical bars 440 essentially are similar to the posts 430 in embodiments 4B and 4C except that they are attached to connect all the stacked disks 420 together.

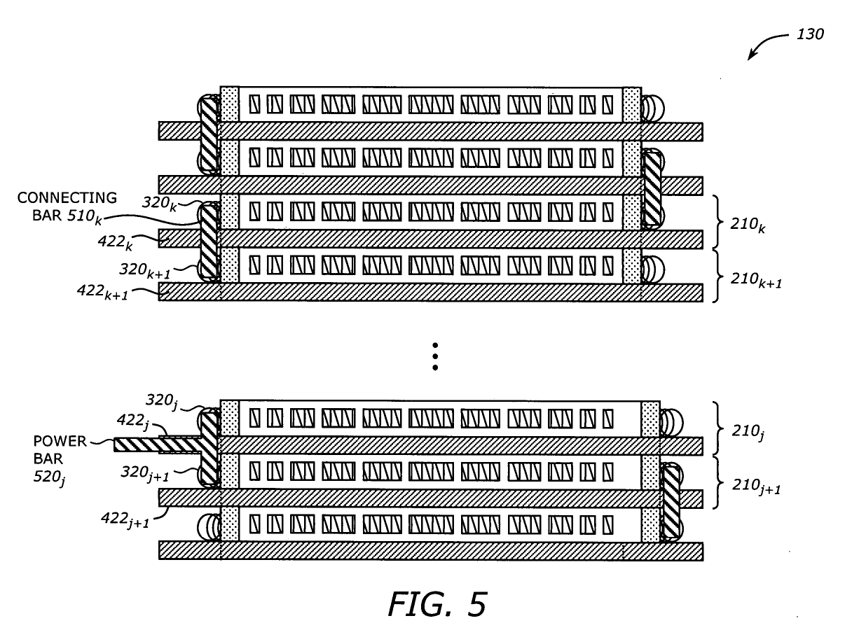

FIG. 5 is a diagram illustrating a connecting bar and a power bar according to one embodiment of the invention. FIG. 5 shows a cross-sectional view of the heating core 130.

The heating element 320ₖ in the heating element structure 210ₖ is connected to the heating element 320ₖ₊₁ in the heating element structure 210ₖ₊₁ by a connecting bar 510ₖ. The connecting bar 510ₖ is attached, or welded, to the end of the heating element 320ₖ at the recess 422ₖ and to the end of the heating element 320ₖ₊₁ at the recess 422ₖ₊₁. Similarly, a power bar 520ⱼ is attached, or welded, to the end of the heating element 320ⱼ at the recess 422ⱼ and to the end of the heating element 320ⱼ₊₁ at the recess 422ⱼ₊₁. The power bar 520ⱼ serves dual purposes. One is to connect the two heating elements together like the connecting bar 510ₖ. One is to provide a terminal to connect to the power source 160 (FIG. 1). The connecting bar 510ₖ and the power bar 520ⱼ may be made of any conductive material such as metal with sufficient size for mechanical and electrical stability.

The heating elements 320₁ to 320_{N} are, therefore, connected in a zigzag pattern from the top tray to the bottom tray, forming an electrically continuous wire. Power bars 520ⱼ's are provided at selected heating zones to provide proper electrical power for different amounts of heat to be generated.

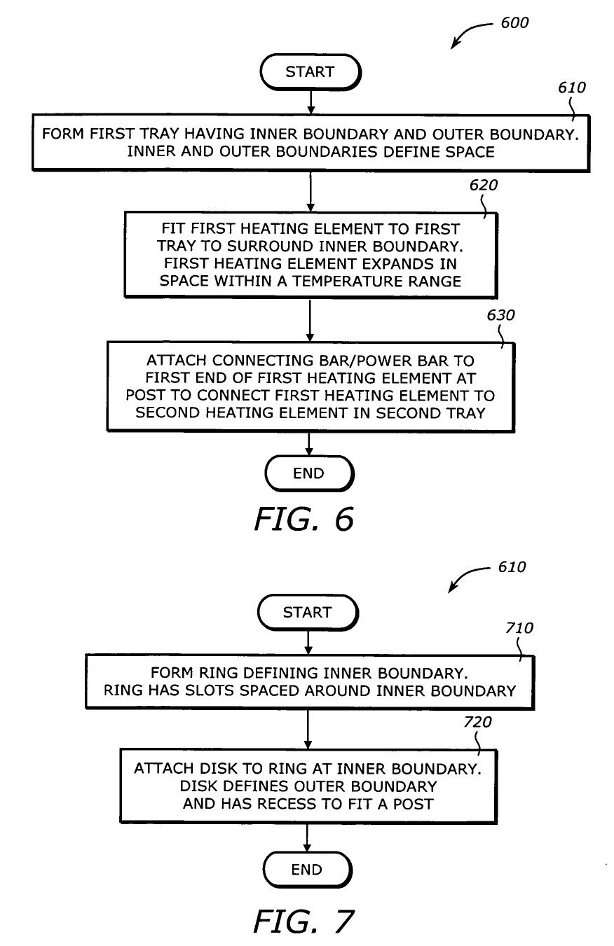

FIG. 6 is a flowchart illustrating a process 600 to form the heating core according to one embodiment of the invention.

Upon START, the process 600 forms a first tray having an inner boundary and an outer boundary (Block 610). The inner and outer boundaries define a space. Next, the process 600 fits or places a first heating element to the first tray to surround the inner boundary (Block 620). The first heating element and the height of the first tray defines a vertical space above the first heating element. The first heating element generates heat when power is applied. It may expand, elongate, or deform in the space within a temperature range during its life.

Then, the process 600 attaches a connecting bar or a power bar to a first end of the first heating element at the post to connect the first heating element to a second heating element in a second tray (Block 630). The power bar is connected to a power source. The second tray is stacked above or below the first tray. The process 600 is then terminated.

FIG. 7 is a flowchart illustrating the process 610 shown in FIG. 6 to form a tray according to one embodiment of the invention. The process 610 shown in FIG. 7 corresponds to the tray shown in FIG. 4A.

Upon START, the process 610 forms a ring defining the inner boundary (Block 710). The ring has a plurality of slots spaced around the inner boundary. The ring has a ring height. The ring height is fit to the size or diameter of the heating elements in addition to a vertical space, if necessary. The plurality of slots provides heat transfer to the core when the heating element generates heat.

Next, the process 610 attaches a disk to the ring at the inner boundary (Block 720). The disk defines the outer boundary. It has a recess to fit a post. The process 610 is then terminated. The disk and the ring may be attached, glued, or welded together from two separate pieces. Alternatively, they may be constructed integrally to form a single piece.

The process 610 may be modified to form the tray in accordance to FIGS. 4B, 4C, and 4D. For example, instead of forming a ring, the process may attach vertical posts on the disk or a plurality of vertical bars that attach to all the stacked disks. In addition, the disk may be formed including the base and the integral vertical posts.

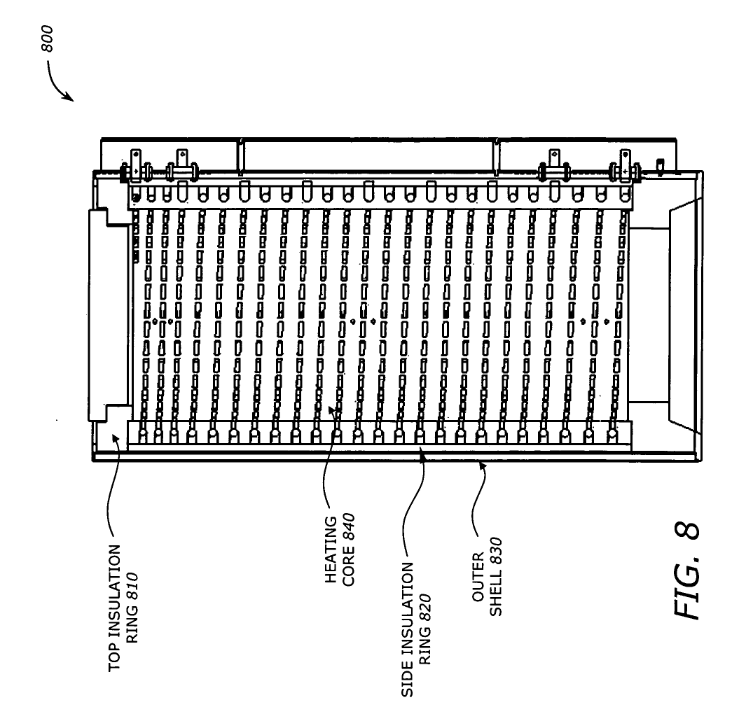

FIG. 8 is a diagram illustrating a system 800 using machined or formed channel according to one embodiment of the invention. The system 800 includes a top insulation ring 810, a side insulation ring 820, an outer shell 830, and a heating core 840. The system 800 shown in FIG. 8 is similar to the system 100 shown in FIG. 1 except that the heating core 840 is different.

The top insulation ring 810, the side insulation ring 820, and the outer shell 830 are similar to the corresponding parts of the system 100 shown in FIG. 1. Therefore, their description is not repeated here.

The heating core 840 has specific grooves machined or formed into the outer diameter of the core cylinder in a spiral or parallel shape. The core 840 may be in the shape of a cylinder, polygon or rectangle, or any suitable shape. The depth of the groove is determined by the shape and size of the heating element and the space to allow for expansion.

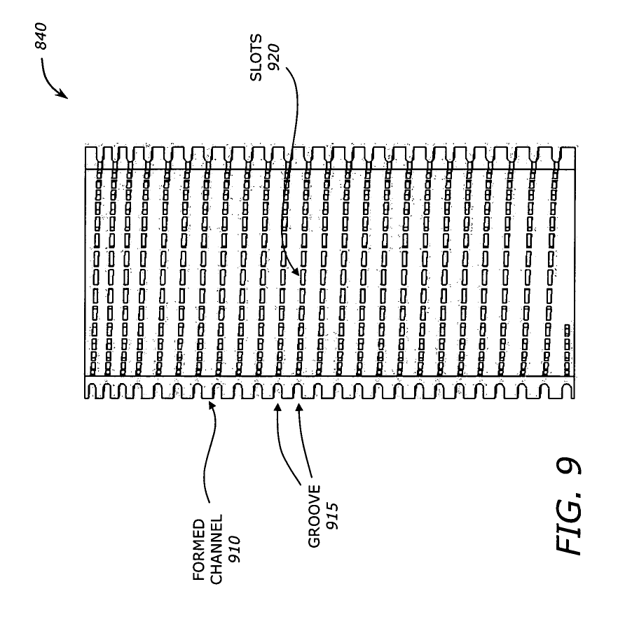

FIG. 9 is a diagram illustrating the heating core 840 shown in FIG. 8 according to one embodiment of the invention. The heating core 840 includes a formed channel 910 and slots 920.

The formed channel 910 is formed into the outer diameter of the core cylinder in a spiral or parallel shape. It may be implemented by a specific machining procedure. The formed channel 910 has slots (or holes) 920 that are made at equally distant spaces in the center of the groove. The purpose for the slots 920 is to allow for quick heat transfer from the heating element to the process area, at the center of the heater. The equally distant sections between the slots 920 provide for two functions; first, to support and preserve the original shape of the cylinder; and second, to serve as a barrier to the heating element should it try to move out of its location.

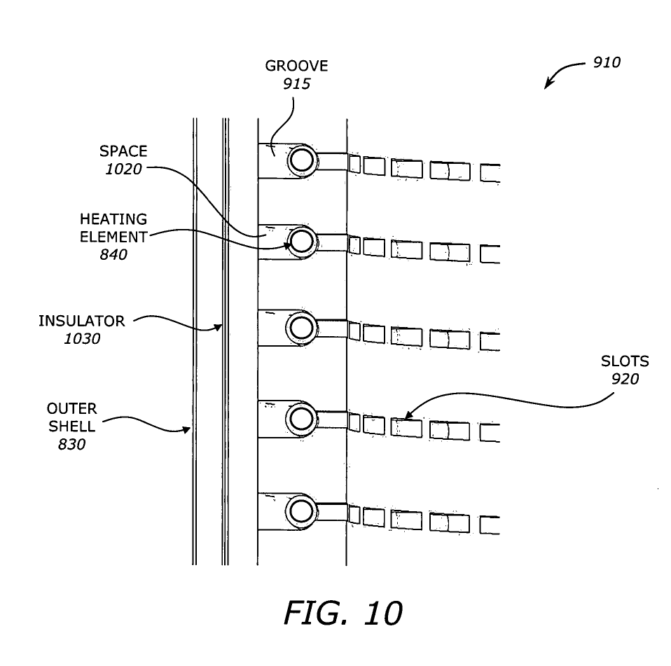

FIG. 10 is a diagram illustrating the formed channel 910 according to one embodiment of the invention.

The formed channel 910 has groves 915 that are designed specifically for the shape of heating element 1010. The groove 915 provides a space 1020 to allow for the expansion or growth of the heating element 1010. The channel 910 also supports the heating element 1010 against gravitational forces. The heating structure is therefore mechanically stable.

The heating element 1010 is essentially similar to the heating element 230 shown in FIG. 2. The heating element 1010 is placed inside the groove 915. After all the heating elements are placed, insulation layer or blankets 840 and outer shell 830 are wrapped around the core 840 accordingly. The insulation blanket 840 may act as the barrier to movement of the heating element 1010 when it exceeds the length of the channel toward the outer diameter of the core.

Within the channel, the space 1020 is provided to allow for the expansion, elongation, or movement of the heating element 1010 at high temperatures. The size of the space 1020 may be similar to the size of the space 240 shown in FIG. 2. Additionally the groove 920 may provide space around the heating element 1010 to accommodate expansion in several directions including vertical and horizontal directions.

Placement of parallel channels or one channel in shape of a spiral allows for the uniform and continuous placement of the heating element 1010 throughout its length. This maintains a uniform temperature throughout the heater and more specifically, the area located in the center called “flat zone”. The flat zone is where the semiconductor product will be processed, and the uniformity of the temperature impacts the semiconductor product performance. This area is typically controlled to a tolerance of +/−0.1-0.25 degrees C., depending on the application. The ability to control the resistance wire spacing accurately in the fashion explained above contributes greatly to achieving the required temperature uniformity.

The manufacturing process continues by placing supporting insulation rings at the two ends of the heater element, adjacent to the core of the heater. Stainless steel rings are then welded at the two ends, finalizing the structure of the heating element. Following this step, the necessary parts are added to the outer stainless steel shell for the support of terminal bars, providing the connection to power lines, and the support of thermocouples. The final step is to place the warning labels on the heater.

As in the embodiment shown in FIG. 1, the operating temperature range of the heater may be in a range between 25° C. to 1700° C. The resistance wire may be any commonly used material such as Kanthal, Super-Kanthal, Molybdenum Disilicide, etc. The final heating element assembly is placed in the diffusion furnace, where the computer system will control the heater to a given temperature prior to the processing of the semiconductor substrates. From a manufacturing standpoint, embodiments of the invention make the heating element manufacturing much simpler and faster in comparison to methods employing ceramic separators. This advantage provides savings in the manufacturing cost of heating elements.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
a first tray having an inner boundary and an outer boundary, the inner and outer boundaries defining a space; and
a first heating element fit to the first tray and surrounding the inner boundary to generate heat when power is applied, the heating element expanding in the space within a temperature range.

2. The apparatus of claim 1 wherein the first tray comprises:
a ring defining the inner boundary and having a plurality of slots spaced around the inner boundary, the ring having a ring height, the plurality of slots providing heat transfer when the heating element generates heat; and
a disk attached to the ring at the inner boundary and defining the outer boundary, the disk having a recess to fit a post.

3. The apparatus of claim 2 wherein the first heating element comprises:
a wire having a wire shape fitting to the ring height with a vertical space and surrounding the plurality of slots.

4. The apparatus of claim 3 wherein the wire shape is one of a helical shape, a solid shape, and a flat shape.

5. The apparatus of claim 1 wherein the space having a size of 0.1 inch to 25 inches.

6. The apparatus of claim 5 further comprising:
a connecting bar attached to a first end of the first heating element at the post to connect the first heating element to a second heating element in a second tray, the second tray being stacked above or below the first tray.

7. The apparatus of claim 5 further comprising:
a power bar attached to a first end of the first heating element at the post to connect the first heating element to a second heating element in a second tray, the second tray being stacked above or below the first tray, the power bar connecting to a power source.

8. A method comprising:
forming a first tray having an inner boundary and an outer boundary, the inner and outer boundaries defining a space; and
fitting a first heating element to the first tray to surround the inner boundary, the first heating element generating heat when power is applied and expanding in the space within a temperature range.

9. The method of claim 8 wherein the forming the first tray comprises:
forming a ring defining the inner boundary and having a plurality of slots spaced around the inner boundary, the ring having a ring height, the plurality of slots providing heat transfer when the heating element generates heat; and
attaching a disk the ring at the inner boundary, the disk defining the outer boundary and having a recess to fit a post.

10. The method of claim 9 wherein fitting the first heating element comprises:
fitting a wire having a wire shape fitting to the ring height with a vertical space and surrounding the plurality of slots.

11. The method of claim 10 wherein the wire shape is one of a helical shape, a solid shape, and a flat shape.

12. The method of claim 8 wherein the space having a size of 0.1 inch to 25 inches.

13. The method of claim 12 further comprising:
attaching a connecting bar to a first end of the first heating element at the post to connect the first heating element to a second heating element in a second tray, the second tray being stacked above or below the first tray.

14. The method of claim 12 further comprising:
attaching a power bar to a first end of the first heating element at the post to connect the first heating element to a second heating element in a second tray, the second tray being stacked above or below the first tray; and
connecting the power bar to a power source.

15. A furnace comprising:
a shield;
an insulation layer enclosed by the shield; and
a heating core enclosed by the insulation layer, the heating core comprising a plurality of heating element structures, each of the heating element structures comprising:
a first tray having an inner boundary and an outer boundary, the inner and outer boundaries defining a space, and
a first heating element fit to the first tray and surrounding the inner boundary to generate heat when power is applied, the heating element expanding in the space within a temperature range.

16. The furnace of claim 15 wherein the first tray comprises:
a ring defining the inner boundary and having a plurality of slots spaced around the inner boundary, the ring having a ring height, the plurality of slots providing heat transfer when the heating element generates heat; and
a disk attached to the ring at the inner boundary and defining the outer boundary, the disk having a recess to fit a post.

17. The furnace of claim 16 wherein the first heating element comprises:
a wire having a wire shape fitting to the ring height with a vertical space and surrounding the plurality of slots.

18. The furnace of claim 17 wherein the wire shape is one of a helical shape, a solid shape, and a flat shape.

19. The furnace of claim 15 wherein the space having a size of 0.1 inch to 25 inches.

20. The furnace of claim 19 wherein each of the heating element structures further comprises:
a connecting bar attached to a first end of the first heating element at the post to connect the first heating element to a second heating element in a second tray, the second tray being stacked above or below the first tray.

21. The furnace of claim 19 wherein each of the heating element structures further comprises:
a power bar attached to a first end of the first heating element at the post to connect the first heating element to a second heating element in a second tray, the second tray being stacked above or below the first tray, the power bar connecting to a power source.
